(19) United States
(12) Patent Application Publication
(10) Pub. No.: US 2019/0283734 A1
(43) Pub. Date: Sep. 19, 2019

(54) VEHICLE STABILITY CONTROL DEVICE

(71) Applicant: TOYOTA JIDOSHA KABUSHIKI KAISHA, Toyota-shi (JP)

(72) Inventors: Etsuo KATSUYAMA, Hiratsuka-shi (JP); Takao KOBAYASHI, Nagakute-shi (JP)

(73) Assignee: TOYOTA JIDOSHA KABUSHIKI KAISHA, Toyota-shi (JP)

(21) Appl. No.: 16/253,381

(22) Filed: Jan. 22, 2019

(30) Foreign Application Priority Data
Mar. 19, 2018 (JP) 2018-051101

(51) Int. Cl. B60W 30/045; B60W 30/18; B60W 40/114; B60W 40/109

(52) U.S. Cl. CPC B60W 30/045; B60W 30/18145; B60W 2040/1315; B60W 40/109; B60W 40/114

(57) ABSTRACT

A vehicle stability control device mounted on a vehicle includes: a yaw moment generation device configured to generate a yaw moment; and a control device configured to control the yaw moment generation device to generate a counter yaw moment that counteracts a variation yaw moment generated when the vehicle makes a turn. The counter yaw moment is expressed by F_{D r i v e r}×h×A_{y}/g, wherein F_{D r i v e r} is a required driving force required for the vehicle, h is a center of gravity height of the the vehicle, A_{y} is a lateral acceleration of the vehicle, and g is a gravitational acceleration.

### BACKGROUND

### Technical Field

The present disclosure relates to vehicle stability control when a vehicle makes a turn.

### Background Art

When a vehicle performs acceleration or deceleration during a turn, load transfer occurs, a turning radius changes, and steering characteristics vary. For example, when a vehicle accelerates during a turn, understeer characteristics become stronger. To the contrary, when a vehicle decelerates during a turn, oversteer characteristics become stronger. To suppress such the variation in steering characteristics is important from a viewpoint of vehicle stabilization.

Patent Literature 1 discloses a technique of controlling a yaw moment of a vehicle for suppressing the variation in steering characteristics as mentioned above. More specifically, a variation yaw moment generated by acceleration or deceleration during a turn is estimated. Then, the vehicle is controlled such that a counter yaw moment for counteracting the variation yaw moment is generated. The counter yaw moment can be generated, for example, by generating a braking force at a turning outer wheel or a turning inner wheel.

### LIST OF RELATED ART

Patent Literature 1: Japanese Unexamined Patent Application Publication No. JP-H09-86203

### SUMMARY

“Running resistance” such as rolling resistance and air resistance acts on a vehicle that is running. When the vehicle makes a turn, the running resistance also influences the variation yaw moment. However, according to Patent Literature 1 described above, the influence of the running resistance is not considered, and thus the counter yaw moment may be too large or too small. The counter yaw moment being too large or too small deteriorates accuracy of vehicle stability control, which is not preferable.

An object of the present disclosure is to provide a technique that can improve accuracy of vehicle stability control when a vehicle makes a turn.

A first disclosure is directed to a vehicle stability control device mounted on a vehicle.

The vehicle stability control device includes:

a yaw moment generation device configured to generate a yaw moment; and

a control device configured to control the yaw moment generation device to generate a counter yaw moment that counteracts a variation yaw moment generated when the vehicle makes a turn.

The counter yaw moment is expressed by F_{D r i v e r}×h×A_{y}/g,

wherein F_{D r i v e r} is a required driving force required for the vehicle,

h is a center of gravity height of the the vehicle,

A_{y} is a lateral acceleration of the vehicle, and

g is a gravitational acceleration.

A second disclosure is directed to a vehicle stability control device mounted on a vehicle.

The vehicle stability control device includes:

a yaw moment generation device configured to generate a yaw moment; and

a control device configured to control the yaw moment generation device to generate a counter yaw moment that counteracts a variation yaw moment generated when the vehicle makes a turn.

The counter yaw moment not considering running resistance is a basic counter yaw moment.

The counter yaw moment considering the running resistance is a corrected counter yaw moment that is expressed by a sum of the basic counter yaw moment and an offset yaw moment.

A direction of the offset yaw moment is a direction to promote the turn of the vehicle.

The control device controls the yaw moment generation device to generate the corrected counter yaw moment.

The vehicle stability control device according to the present disclosure generates the counter yaw moment for counteracting the variation yaw moment generated when the vehicle makes a turn. The counter yaw moment is determined in consideration of the influence of the running resistance. Since the influence of the running resistance is considered, the accuracy of the vehicle stability control is improved. This contributes to increase in confidence in the vehicle stability control.

### BRIEF DESCRIPTION OF DRAWINGS

FIG. 1 is a conceptual diagram for explaining a vehicle and a vehicle stability control device according to an embodiment of the present disclosure;

FIG. 2 is a conceptual diagram for explaining a variation yaw moment in the embodiment of the present disclosure;

FIG. 3 is a conceptual diagram for explaining a basic counter yaw moment and a corrected counter yaw moment in the embodiment of the present disclosure;

FIG. 4 is a conceptual diagram for explaining a second variation yaw moment caused by air resistance in the embodiment of the present disclosure; and

FIG. 5 is a block diagram showing a configuration example of a vehicle stability control device according to the embodiment of the present disclosure.

### EMBODIMENTS

Embodiments of the present disclosure will be described below with reference to the attached drawings.

### 1. Outline

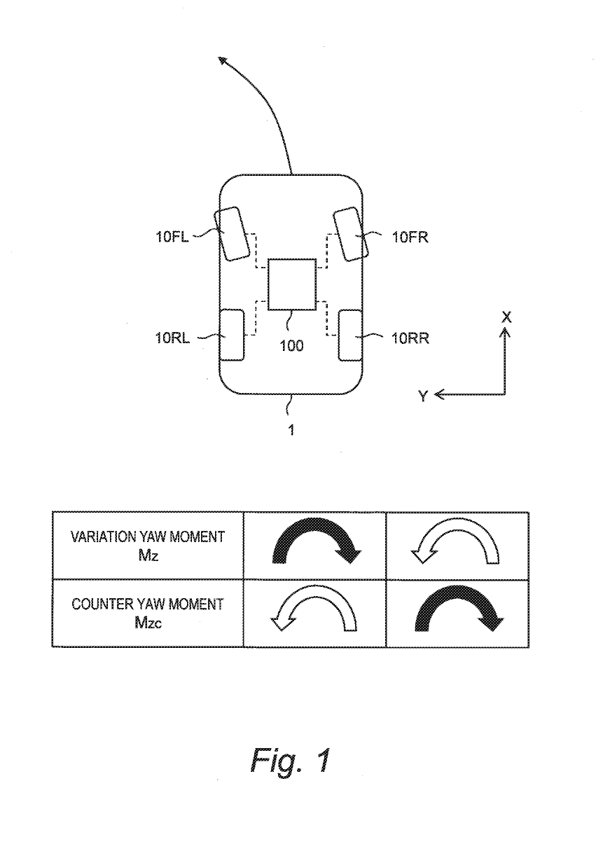

FIG. 1 is a conceptual diagram for explaining a vehicle 1 and a vehicle stability control device 100 according to the present embodiment. The vehicle 1 is provided with wheels 10. The wheels 10 includes a left front wheel 10FL, a right front wheel 10FR, a left rear wheel 10RL, and a right rear wheel 10RR. In the following description, the left front wheel 10FL and the right front wheel 10FR are collectively referred to as a “front wheel”, and the left rear wheel 10RL and the right rear wheel 10RR are collectively referred to as a “rear wheel”. The left front wheel 10FL and the left rear wheel 10RL are collectively referred to as a “left wheel”, and the right front wheel 10FR and the right rear wheel 10RR are collectively referred to as a “right wheel”.

The vehicle stability control device 100 is mounted on the vehicle 1 and executes vehicle stability control. In the present embodiment, we especially consider the vehicle stability control when the vehicle 1 makes a turn. In the following description, turn-and-acceleration/deceleration mean that a turn-and-acceleration or deceleration of the vehicle 1 are performed simultaneously. Therefore, the turn-and-acceleration/deceleration includes both acceleration or deceleration being performed during a turn-and-a turn being performed during acceleration or deceleration. It can be said that the turn-and-acceleration/deceleration is a state where both a longitudinal acceleration and a lateral acceleration are generated.

Due to the turn-and-acceleration/deceleration, load transfer occurs, a turning radius changes, and steering characteristics vary. For example, when the vehicle 1 accelerates during a turn, understeer characteristics become stronger. To the contrary, when the vehicle 1 decelerates during a turn, oversteer characteristics become stronger. To suppress such the variation in steering characteristics is important from a viewpoint of vehicle stabilization. The vehicle stability control device 100 according to the present embodiment executes yaw moment control in order to suppress the variation in steering characteristics caused by the turn-and-acceleration/deceleration and thus to stabilize behavior of the vehicle 1.

More specifically, a yaw moment of the vehicle 1 varies due to the turn-and-acceleration/deceleration. Such the variation in the yaw moment is hereinafter referred to as a “variation yaw moment M_{z}”. A moment that counteracts the variation yaw moment M_{z} is hereinafter referred to as a “counter yaw moment M_{z c}”. An arrow in FIG. 1 indicates a direction of rotation (yaw) of the vehicle 1 due to each yaw moment. The vehicle stability control device 100 generates the counter yaw moment M_{z c} counteracting the variation yaw moment M_{z} to suppress the variation in steering characteristics.

It should be noted here that “running resistance” such as rolling resistance and air resistance acts on the vehicle 1 that is running. When the vehicle 1 makes a turn, the running resistance also influences the variation yaw moment M_{z}. In view of the above, according to the present embodiment, the variation yaw moment M_{z} and the counter yaw moment M_{z c} are calculated in consideration of the influence of the running resistance.

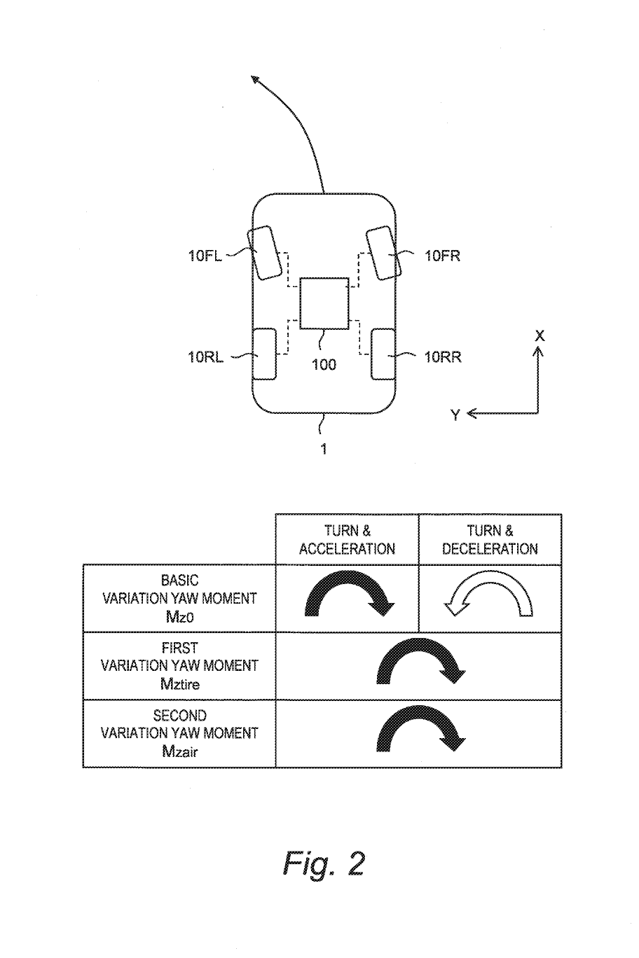

FIG. 2 is a conceptual diagram for explaining the variation yaw moment M_{z} in the present embodiment. In the present embodiment, three types of variation yaw moment: a basic variation yaw moment M_{z 0}, a first variation yaw moment M_{z t i r e}, and a second variation yaw moment M_{z a i r} are considered.

First, the basic variation yaw moment M_{z 0} is a conventional variation yaw moment not considering the running resistance. As described in Patent Literature 1 and so forth, the conventional basic variation yaw moment M_{z 0} is expressed by the following Equation (1). Here, m is a vehicle mass, g is a gravitational acceleration, h is a center of gravity height of the vehicle 1, Aₓ is a longitudinal acceleration of the vehicle 1, and A_{y} is a lateral acceleration of the vehicle 1.

$$\begin{matrix}[ Equation ( 1 ) ] & \\ {M}_{z 0} = - mgh \frac{{A}_{x}}{g} \frac{{A}_{y}}{g} & ( 1 )\end{matrix}$$

The basic variation yaw moment M_{z 0} depends on the longitudinal acceleration Aₓ and the lateral acceleration A_{y}. An arrow in FIG. 2 indicates a direction of rotation (yaw) of the vehicle 1 due to each variation yaw moment when a turning direction of the vehicle 1 is a left direction. In a case of turn-and-acceleration (Aₓ>0), the basic variation yaw moment M_{z 0} acts in a direction to suppress the turn of the vehicle 1. On the other hand, in a case of turn-and-deceleration (Aₓ<0), the basic variation yaw moment M_{z 0} acts in a direction to promote the turn of the vehicle 1.

Next, the first variation yaw moment M_{z t i r e} is the variation yaw moment caused by the rolling resistance. The rolling resistance of each wheel 10 depends on a vertical load and increases as the vertical load increases. In the case of the turn in the left direction as shown in FIG. 2, the vertical load on the right wheel (i.e. outer wheel) is larger than the vertical load on the left wheel (i.e. inner wheel). Therefore, a difference in the rolling resistance between the right wheel and the left wheel occurs. The first variation yaw moment M_{z t i r e} is caused by the difference in the rolling resistance between the left and right wheels. As shown in FIG. 2, the first variation yaw moment M_{z t i r e} acts in a direction to suppress the turn of the vehicle 1 regardless of acceleration or deceleration. In addition, the first variation yaw moment M_{z t i r e} is caused not only when the turn-and-acceleration/deceleration is performed but also when the vehicle 1 makes a turn at a constant speed.

Next, the second variation yaw moment M_{z a i r} is the variation yaw moment caused by the air resistance. A point of application of an air resistance force to the vehicle 1 is apart upward from a contact patch of the wheel 10. Therefore, the air resistance force acts to cause a pitch moment and thus rearward load transfer. Due to the rearward load transfer, the understeer characteristics are strengthened. That is, the second variation yaw moment M_{z a i r} acting in a direction to suppress the turn of the vehicle 1 is caused. The second variation yaw moment M_{z a i r} is caused not only when the turn-and-acceleration/deceleration is performed but also when the vehicle 1 makes a turn at a constant speed.

As can be seen from FIG. 2, in the case of the turn-and-acceleration (Aₓ>0), the directions of the first variation yaw moment M_{z t i r e} and the second variation yaw moment M_{z a i r} are opposite to the direction of the basic variation yaw moment M_{z 0}. On the other hand, in the case of the turn-and-deceleration (Aₓ<0), the directions of the first variation yaw moment M_{z t i r e} and the second variation yaw moment M_{z a i r} are the same as the direction of the basic variation yaw moment M_{z 0}. Therefore, the basic variation yaw moment M_{z 0} calculated by the above-described Equation (1) is too large or too small as compared with an actual variation yaw moment M_{z}.

According to the present embodiment, the counter yaw moment M_{z c} is calculated in consideration of the running resistance. The counter yaw moment M_{z c} considering the running resistance is expressed by the following Equation (2).

[Equation (2)]

M_{zc}=M_{zc0}+M_{zc_off} (2)

M_{z c 0} in Equation (2) is the counter yaw moment that counteracts the basic variation yaw moment M_{z 0}, and hereinafter referred to as a “basic counter yaw moment M_{z c 0}”. That is the basic counter yaw moment M_{z c 0} is a conventional counter yaw moment not considering the running resistance. The basic counter yaw moment M_{z c 0} is expressed by the following Equation (3).

$$\begin{matrix}[ Equation ( 3 ) ] & \\ {M}_{zc 0} = - {M}_{z 0} = mgh \frac{{A}_{x}}{g} \frac{{A}_{y}}{g} & ( 3 )\end{matrix}$$

M_{z c _ o f f} in Equation (2) is an offset (difference) of the counter yaw moment M_{z c} from the basic variation yaw moment M_{z 0}, and hereinafter referred to as an “offset yaw moment M_{z c _ o f f}”. The offset yaw moment M_{z c _ o f f} is the counter yaw moment that counteracts at least a part of the first variation yaw moment M_{z t i r e} and the second variation yaw moment M_{z a i r} described above. As can be seen from FIG. 2, a direction of the offset yaw moment M_{z c _ o f f} is a direction to promote the turn of the vehicle 1.

As described above, the counter yaw moment M_{z c} according to the present embodiment is expressed by a sum of the basic counter yaw moment M_{z c 0} and the offset yaw moment M_{z c _ o f f}. It can be said that the counter yaw moment M_{z c} is corrected from the basic counter yaw moment M_{z c 0} by the offset yaw moment M_{z c _ o f f} reflecting the influence of the running resistance. In this sense, the counter yaw moment M according to the present embodiment is also called a “corrected counter yaw moment M_{z c}”.

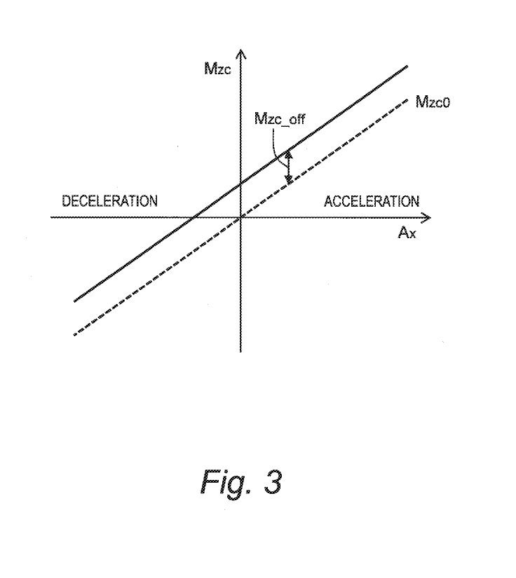

FIG. 3 is a conceptual diagram for explaining the basic counter yaw moment M_{z c 0} and the corrected counter yaw moment M_{z c}. A horizontal axis represents the longitudinal acceleration Aₓ. In the example shown in FIG. 3, the lateral acceleration A_{y} is a certain positive value. The basic counter yaw moment M_{z c 0} varies according to the longitudinal acceleration Aₓ (see Equation (3)). The corrected counter yaw moment M_{z c} is corrected from the basic counter yaw moment M_{z c 0} by the offset yaw moment M_{z c _ o f f} reflecting the influence of the running resistance. In particular, influence of the correction is relatively large in a region where the longitudinal acceleration Aₓ is low. Moreover, even when the longitudinal acceleration Aₓ is 0, the corrected counter yaw moment M_{z c} is required. Therefore, the corrected counter yaw moment M_{z c} according to the present embodiment can be applied not only to the case of the turn-and-acceleration/deceleration but also to the case where the vehicle 1 makes a turn at a constant speed.

The vehicle stability control device 100 according to the present embodiment executes the vehicle stability control by generating the corrected counter yaw moment M_{z c} instead of the basic counter yaw moment M_{z c 0} when the vehicle 1 makes a turn. Since the influence of the running resistance is considered, the accuracy of the vehicle stability control is improved. This contributes to increase in confidence in the vehicle stability control.

Moreover, according to the present embodiment, the variation yaw moment M_{z} is canceled out and thus change in the turning radius is suppressed. This means that a travel direction of the vehicle 1 is not disturbed even when the turn-and-acceleration/deceleration is performed. Therefore, maneuverability of the vehicle 1 is improved.

Furthermore, when the vehicle stability control device 100 according to the present embodiment is applied to an autonomous driving vehicle, followability to a target path is improved.

### 2. Derivation of Various Equations

### 2-1. First Variation Yaw Moment M_{z t i r e}

First, equations relating to the first variation yaw moment M_{z t i r e} caused by the rolling resistance will be described. A tire resistance force F_{t i r e} acting on a contact patch of the tire is expressed by the following Equation (4). A parameter “c” in Equation (4) is a tire resistance coefficient.

[Equation (4)]

Fₜᵢᵣₑ=−cmg (4)

The first variation yaw moment M_{z t i r e} is expressed by the following Equation (5). In Equation (5), F_{z f l}, F_{z f r}, F_{z r l}, and F_{z r r} are the vertical loads on the left front wheel 10FL, the right front wheel 10FR, the left rear wheel 10RL, and the right rear wheel 10RR, respectively, and t_{f} and tᵣ are tracks (treads) of the front wheel and the rear wheel, respectively.

$$\begin{matrix}[ Equation ( 5 ) ] & \\ {M}_{ztire} = - c [ ( {F}_{zfr} - {F}_{zfl} ) \frac{{t}_{f}}{2} + ( {F}_{zrr} - {F}_{zrl} ) \frac{{t}_{r}}{2} ] & ( 5 )\end{matrix}$$

Meanwhile, the following Equation (6) is satisfied with regard to a roll moment (mA_{y} h) of the vehicle 1.

$$\begin{matrix}[ Equation ( 6 ) ] & \\ m {A}_{y} h = ( {F}_{zfr} - {F}_{zfl} ) \frac{{t}_{f}}{2} + ( {F}_{zrr} - {F}_{zrl} ) \frac{{t}_{r}}{2} & ( 6 )\end{matrix}$$

Therefore, the first variation yaw moment M_{z t i r e} is expressed by the following simple Equation (7).

$$\begin{matrix}[ Equation ( 7 ) ] & \\ {M}_{ztire} = - cmgh \frac{{A}_{y}}{g} = {F}_{tire} h \frac{{A}_{y}}{g} & ( 7 )\end{matrix}$$

The first variation yaw moment M_{z t i r e} does not depend on the longitudinal acceleration Aₓ but on the lateral acceleration A_{y}. Especially, the first variation yaw moment M_{z t i r e} greatly influences the steering characteristics in a region where the lateral acceleration A_{y} is high.

### 2-2. Second Variation Yaw Moment M_{z a i r}

Next, equations relating to the second variation yaw moment M_{z a i r} caused by the air resistance will be described. The air resistance force F_{a i r} acting on the vehicle 1 is expressed by the following Equation (8). In Equation (8), ρ is air density, C_{d} is an air resistance coefficient, A is a forward projected area of the vehicle 1, and V is a vehicle speed (i.e. a speed of the vehicle 1).

$$\begin{matrix}[ Equation ( 8 ) ] & \\ {F}_{air} = - \frac{1}{2} ρ {C}_{d} {AV}^{2} & ( 8 )\end{matrix}$$

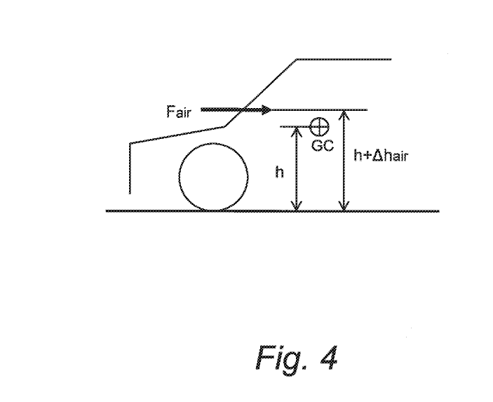

As shown in FIG. 4, a height of the point of application of the air resistance force F_{a i r} is expressed by a sum of the center of gravity height h and a difference Δh_{a i r}. The air resistance force F_{a i r} acts to cause a pitch moment and thus rearward load transfer. The second variation yaw moment M_{z a i r} caused by the rearward load transfer is expressed by the following Equation (9).

$$\begin{matrix}[ Equation ( 9 ) ] & \\ {M}_{zair} = {F}_{air} ( h + Δ {h}_{air} ) \frac{{A}_{y}}{g} = - \frac{1}{2} ρ {C}_{d} {AV}^{2} ( h + Δ {h}_{air} ) \frac{{A}_{y}}{g} & ( 9 )\end{matrix}$$

The second variation yaw moment M_{z a i r} does not depend on the longitudinal acceleration Aₓ but on the vehicle speed V and the lateral acceleration A_{y}. Especially, the second variation yaw moment M_{z a i r} greatly influences the steering characteristics in a region where the vehicle speed V is high.

### 2-3. Corrected Counter Yaw Moment M_{z c}

The corrected counter yaw moment M_{z c} according to the present embodiment counteracts not only the basic variation yaw moment M_{z 0} but also at least a part of the first variation yaw moment M_{z t i r e} and the second variation yaw moment M_{z a i r}. For example, the corrected counter yaw moment M_{z c} is expressed by the following Equation (10).

[Equation (10)]

M_{zc}=−(M_{z0}+M_{ztire}+M_{zair}) (10)

Equation (10) is transformed into the following Equation (11) by the use of the above-described Equations (1), (7), and (9).

$$\begin{matrix}[ Equation ( 11 ) ] & \\ {M}_{zc} = mgh \frac{{A}_{x}}{g} \frac{{A}_{y}}{g} + cmgh \frac{{A}_{y}}{g} + \frac{1}{2} ρ {C}_{d} {AV}^{2} ( h + Δ {h}_{air} ) \frac{{A}_{y}}{g} & ( 11 )\end{matrix}$$

When the height of the point of application of the air resistance force F_{a i r} is equal to or can be considered to be equal to the center of gravity height h, Δh_{a i r} is zero. In this case, the corrected counter yaw moment M_{z c} is expressed by the following Equation (12).

$$\begin{matrix}[ Equation ( 12 ) ] & \\ {M}_{zc} = mgh \frac{{A}_{x}}{g} \frac{{A}_{y}}{g} + ( cmg + \frac{1}{2} ρ {C}_{d} {AV}^{2} ) h \frac{{A}_{y}}{g} & ( 12 )\end{matrix}$$

Alternatively, Equation (10) can also be transformed into the following Equation (13) by the use of the tire resistance force F_{t i r e} and the air resistance force F_{a i r}.

$$\begin{matrix}[ Equation ( 13 ) ] & \\ \begin{matrix}{M}_{zc} = mgh \frac{{A}_{x}}{g} \frac{{A}_{y}}{g} - {F}_{tire} h \frac{{A}_{y}}{g} - {F}_{air} ( h + Δ {h}_{air} ) h \frac{{A}_{y}}{g} \\ = ( m {A}_{x} - {F}_{tire} - {F}_{air} ) h \frac{{A}_{y}}{g} - {F}_{air} Δ {h}_{air} \frac{{A}_{y}}{g}\end{matrix} & ( 13 )\end{matrix}$$

Meanwhile, an equation of motion of the vehicle 1 in the longitudinal direction is expressed by the following Equation (14). F_{D r i v e r} in Equation (14) is a required driving force required for the vehicle 1.

[Equation (14)]

mAₓ=Fₜᵢᵣₑ+Fₐᵢᵣ+F_{Driver} (14)

The following Equation (15) can be obtained from the above Equations (13) and (14).

$$\begin{matrix}[ Equation ( 15 ) ] & \\ {M}_{zc} = {F}_{Driver} h \frac{{A}_{y}}{g} - {F}_{air} Δ {h}_{air} \frac{{A}_{y}}{g} & ( 15 )\end{matrix}$$

When the height of the point of application of the air resistance force F_{a i r} is equal to or can be considered to be equal to the center of gravity height h, Δh_{a i r} is zero. In this case, the corrected counter yaw moment M_{z c} is expressed by the following simple Equation (16).

$$\begin{matrix}[ Equation ( 16 ) ] & \\ {M}_{zc} = {F}_{Driver} h \frac{{A}_{y}}{g} & ( 16 )\end{matrix}$$

Using Equation (16) makes it possible to easily determine the corrected counter yaw moment M_{z c} based on the required driving force F_{D r i v e r} and the lateral acceleration A_{y}. In this case, information on the longitudinal acceleration Aₓ is not necessary. Comparing with the above-described Equation (3) expressing the basic counter yaw moment M_{z c 0}, it can be seen that “mAₓ” is replaced by the required driving force F_{D r i v e r}. That is, using the required driving force F_{D r i v e r} instead of “mAₓ” as a force in the longitudinal direction results in that the influence of the running resistance is automatically reflected in the counter yaw moment.

### 3. Configuration Example of Vehicle Stability Control Device

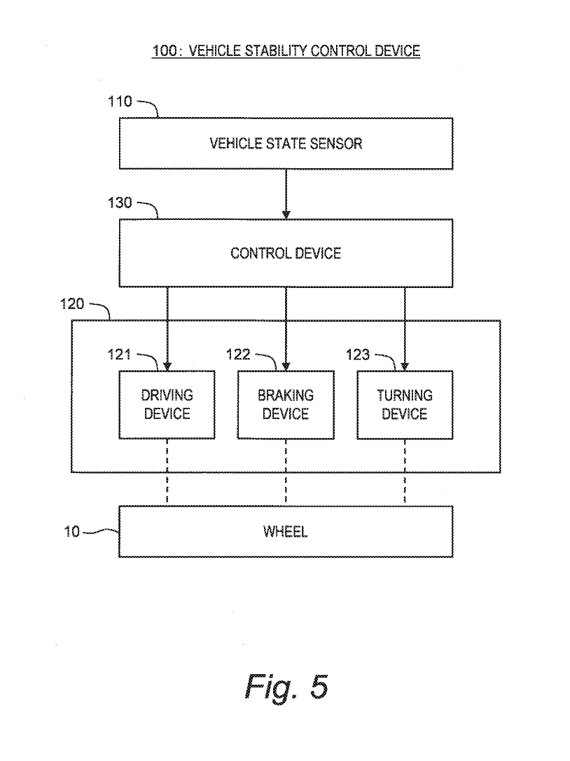

FIG. 5 is a block diagram showing a configuration example of the vehicle stability control device 100 according to the present embodiment. The vehicle stability control device 100 is mounted on the vehicle 1 and executes the vehicle stability control. More specifically, the vehicle stability control device 100 is provided with a vehicle state sensor 110, a yaw moment generation device 120, and a control device 130 (controller).

The vehicle state sensor 110 detects a travel state of the vehicle 1. The vehicle state sensor 110 includes a longitudinal acceleration sensor, a lateral acceleration sensor, a vehicle speed sensor, a wheel speed sensor, and the like. The longitudinal acceleration sensor detects the longitudinal acceleration Aₓ. The lateral acceleration sensor detects the lateral acceleration A_{y}. The wheel speed sensor detects a rotational speed of each wheel 10. The vehicle speed sensor detects the vehicle speed V. The vehicle state sensor 110 sends the detected information to the control device 130.

The yaw moment generation device 120 is a mechanism that generates the yaw moment of the vehicle 1. More specifically, the yaw moment generation device 120 includes at least one of a driving device 121, a braking device 122, and a turning device. 123 The yaw moment generation device 120 may be a combination of some of the driving device 121, the braking device 122, and the turning device 123.

The driving device 121 is configured to be able to individually control respective driving forces of left and right driving wheels. For example, the driving device 121 includes in-wheel motors respectively arranged near the driving wheels. Using the driving device 121 to appropriately control a difference in driving force between left and right driving wheels makes it possible to generate a desired corrected counter yaw moment M_{z c}.

The braking device 122 is configured to be able to individually control respective braking forces of wheels 10. Typically, the braking device 122 includes a brake actuator that is capable of individually controlling respective pressures of brake fluids supplied to wheel cylinders of the wheels 10. Using the braking device 122 to appropriately control a difference in braking force between the left wheel and the right wheel makes it possible to generate a desired corrected counter yaw moment M_{z c}.

The turning device 123 turns the wheel 10. For example, the turning device 123 includes an electric power steering (EPS) device. Using the turning device 123 to appropriately control a steering angle of the wheel 10 makes it possible to generate a desired corrected counter yaw moment M_{z c}.

The control device 130 (controller) controls travel of the vehicle 1. Typically, the control device 130 is a microcomputer including a processor and a memory device. The control device 130 is also called an ECU (Electronic Control Unit). A control program is stored in the memory device. A variety of processing by the control device 130 is achieved by the processor executing the control program stored in the memory device.

For example, the control device 130 actuates the driving device 121 to generate a desired driving force. Moreover, the control device 130 actuates the braking device 122 to generate a desired braking force.

Furthermore, the control device 130 executes the vehicle stability control when the vehicle 1 makes a turn. More specifically, the control device 130 controls the yaw moment generation device 120 to generate the corrected counter yaw moment M_{z c} based on the travel state (Aₓ, A_{y}, V, F_{D r i v e r}) of the vehicle 1. The longitudinal acceleration Aₓ, the lateral acceleration A_{y}, and the vehicle speed V are detected by the vehicle state sensor 110. The vehicle speed V may be calculated from the wheel speed detected by the wheel speed sensor. The required driving force F_{D r i v e r} is a parameter that the control device 130 controlling the driving device 121 and the braking device 122 is always aware of. For example, the required driving force F_{D r i v e r} required by a driver is determined from an amount of operation of an accelerator pedal by the driver. In a case of an autonomous driving vehicle, the required driving force F_{D r i v e r} is determined by an autonomous driving system.

It should be noted that other parameters necessary for calculating the corrected counter yaw moment M_{z c} are fixed values and beforehand stored in the memory device of the control device 130.

### 4. Various Examples of Corrected Counter Yaw Moment M_{z c}

### 4-1. First Example

The control device 130 calculates the corrected counter yaw moment M_{z c} in accordance with the above-described Equation (16). In this case, information of the longitudinal acceleration Aₓ is not necessary, and it is possible to easily calculate the corrected counter yaw moment M_{z c} based on the required driving force F_{D r i v e r} and the lateral acceleration A_{y}.

### 4-2. Second Example

The control device 130 calculates the corrected counter yaw moment M_{z c} in accordance with the above-described Equation (12). In this case, information of the longitudinal acceleration Aₓ, the lateral acceleration A_{y}, and the vehicle speed V is used.

### 4-3. Third Example

The control device 130 calculates the corrected counter yaw moment M_{z c} in accordance with the following Equation (17).

$$\begin{matrix}[ Equation ( 17 ) ] & \\ {M}_{zc} = mgh \frac{{A}_{x}}{g} \frac{{A}_{y}}{g} + {P}_{off} h \frac{{A}_{y}}{g} & ( 17 )\end{matrix}$$

The second term of the right side of Equation (17) represents the offset yaw moment M_{z c _ o f f} (see Equation (2)). A parameter P_{o f f} in the second term is hereinafter referred to as an “offset parameter P_{o f f}”. When the offset parameter P_{o f f} is expressed by the following Equation (18), Equation (17) is equal to the above-described Equation (12).

[Equation (18)]

P_{off}=cmg+1/2ρC_{d}AV² (18)

The offset parameter P_{o f f} is not limited to Equation (18). The following Equation (19) can be used as an approximate expression of Equation (18).

$$\begin{matrix}[ Equation ( 19 ) ] & \\ {P}_{off} = {\sum }_{i = 0}^{n} {a}_{i} {V}^{i} & ( 19 )\end{matrix}$$

It is also possible that a map indicating a correspondence relationship between the vehicle speed V and the offset parameter P_{o f f} is beforehand created and stored in the memory device of the control device 130. The control device 130 acquires the offset parameter P_{o f f} based on the map and the vehicle speed V. In either case, the offset parameter P_{o f f} and thus the offset yaw moment M_{z c _ o f f} increase as the vehicle speed V increases.

Alternatively, the offset parameter P_{o f f} may be set to a constant. For example, the offset parameter P_{o f f} is set to a constant “cmg”. The offset yaw moment M_{z c _ o f f} in this case corresponds to the counter yaw moment that counteracts the first variation yaw moment M_{z t i r e}. (see Equation (7)). Even in this case, a part of the running resistance is taken into consideration, and thus the accuracy of the vehicle stability control is improved as compared with the conventional technique.

### 4-4. Fourth Example

The control device 130 calculates the corrected counter yaw moment M_{z c} in accordance with Equation (11) or Equation (15) described above. Considering the parameter Δh_{a i r} makes it possible to further accurately calculate the corrected counter yaw moment M_{z c}.

### 4-5. Fifth Example

The control device 130 calculates the corrected counter yaw moment M_{z c} in accordance with the following Equation (20).

$$\begin{matrix}[ Equation ( 20 ) ] & \\ {M}_{zc} = {F}_{Driver} h \frac{{A}_{y}}{g} - {M}_{ay} \frac{{A}_{y}}{g} & ( 20 )\end{matrix}$$

M_{a y} in Equation (20) is a component corresponding to Δh_{a i r} out of the entire pitch moment caused by the air resistance force F_{a i r}. When the pitch moment M_{a y} is expressed by the following Equation (21), Equation (20) is equal to the above-described Equation (15).

[Equation (21)]

M_{ay}=FₐᵢᵣΔhₐᵢᵣ=−1/2ρC_{d}AV²Δhₐᵢᵣ (21)

The following Equation (22) may be used as an approximate expression of Equation (21).

$$\begin{matrix}[ Equation ( 22 ) ] & \\ {M}_{ay} = {\sum }_{i = 0}^{n} {b}_{i} {V}^{i} & ( 22 )\end{matrix}$$

It is also possible that a map indicating a correspondence relationship between the vehicle speed V and the pitch moment M_{a y} is beforehand created and stored in the memory device of the control device 130. The control device 130 acquires the pitch moment M_{a y} based on the map and the vehicle speed V. In either case, the pitch moment M_{a y} increases as the vehicle speed V increases. Alternatively, a constant may be used as the pitch moment M_{a y}.

What is claimed is:

1. A vehicle stability control device mounted on a vehicle and comprising:
a yaw moment generation device configured to generate a yaw moment; and
a control device configured to control the yaw moment generation device to generate a counter yaw moment that counteracts a variation yaw moment generated when the vehicle makes a turn,
wherein the counter yaw moment is expressed by F_{D r i v e r}×h×A_{y}/g,
wherein F_{D r i v e r} is a required driving force required for the vehicle,
h is a center of gravity height of the the vehicle,
A_{y} is a lateral acceleration of the vehicle, and
g is a gravitational acceleration.

2. A vehicle stability control device mounted on a vehicle and comprising:
a yaw moment generation device configured to generate a yaw moment; and
a control device configured to control the yaw moment generation device to generate a counter yaw moment that counteracts a variation yaw moment generated when the vehicle makes a turn,
wherein
the counter yaw moment not considering running resistance is a basic counter yaw moment,
the counter yaw moment considering the running resistance is a corrected counter yaw moment that is expressed by a sum of the basic counter yaw moment and an offset yaw moment,
a direction of the offset yaw moment is a direction to promote the turn of the vehicle, and
the control device controls the yaw moment generation device to generate the corrected counter yaw moment.

3. The vehicle stability control device according to claim 2,
wherein the offset yaw moment increases as a speed of the vehicle increases.
